(19) United States
(12) Patent Application Publication
(10) Pub. No.: US 2025/0383607 A1
(43) Pub. Date: Dec. 18, 2025

(54) METHOD AND APPARATUS FOR TRAINING ON IMAGING OF PLASMA LITHOGRAPHY

(71) Applicant: INSTITUTE OF MICROELECTRONICS, CHINESE ACADEMY OF SCIENCES, Beijing (CN)

(72) Inventors: Huwen Ding, Beijing (CN); Yayi Wei, Beijing (CN); Jianfang He, Beijing (CN)

(21) Appl. No.: 18/708,030

(22) PCT Filed: Sep. 15, 2023
(86) PCT No.: PCT/CN2023/118978

§ 371 Date: May 7, 2024

(30) Foreign Application Priority Data
Jun. 19, 2023 (CN) 202310726527.1

(51) Int. Cl. G03F 7/00; G06F 30/27; G06F 111/14

(52) U.S. Cl. CPC G03F 7/705; G06F 30/27; G06F 2111/14

(57) ABSTRACT

A method and an apparatus for training on imaging of plasma lithography. The method comprises: determining a structure for training on an imaging of the plasma lithography is determined, where a training mask pattern repeats periodically along two directions in the structure; constructing a model simulating the structure; obtaining a training image pattern of the plasma lithography is obtained through computation based on the model, where the training image pattern corresponds to the training mask pattern; and training a fast imaging model through the training mask pattern and the training image pattern to obtain a trained imaging model for the training mask pattern.

This application claims priority to Chinese Patent Application No. 202310726527.1, titled “METHOD AND APPARATUS FOR TRAINING ON IMAGING OF PLASMA LITHOGRAPHY”, filed on Jun. 19, 2023 with the China National Intellectual Property Administration, which is incorporated herein by reference in its entirety.

### FIELD

The present disclosure relates to the field of semiconductors, and in particular to a method and an apparatus for training on imaging of plasma lithography.

### BACKGROUND

Photolithography is an important technique for manufacturing semiconductor devices, and develops rapidly along with the semiconductor technology. As a complement for mainstream photolithography means, plasma lithography is quite different from traditional lithography such as deep-ultraviolet lithography (DUVL) and extreme-ultraviolet lithography (EUVL).

The plasma lithography utilizes evanescent waves containing high-frequency information to implement near-field imaging, and thus can break through diffraction limits in the traditional photolithography means. Experiments have revealed that optical resolution under single exposure with a light wavelength of 365 nm can reach 20 nm, i.e., about 1/17 of the light wavelength, and may be even lower. The plasma lithography provides a reliable route to low-cost, large-area, and highly efficient photolithography, and hence draws extensive attention.

Therefore, fast imaging for plasma lithography has become a hot topic in current research.

### SUMMARY

A method and an apparatus for training on imaging of plasma lithography are provided according to embodiments of the present disclosure. A fast imaging model of plasma lithography can be trained to implement fast imaging simulation, such that requirements on plasma lithography can be satisfied in research.

In order to achieve at least the above objective, following technical solutions are provided according to embodiments of the present disclosure.

A method for training on imaging of plasma lithography is provided according to an embodiment of the present disclosure. The method comprises: determining a structure for training on imaging of plasma lithography, where a training mask pattern repeats periodically along two directions in the structure; constructing a model simulating the structure; obtaining a training image pattern of the plasma lithography through computation based on the model, where the training image pattern corresponds to the training mask pattern; and training a fast imaging model through the training mask pattern and the training image pattern to obtain a trained imaging model for the training mask pattern.

In an embodiment, the training mask pattern comprises a first part configured to be transparent and a second part configured to be opaque, where the second part surrounds the first part. Determining the structure for the training on the imaging of the plasma lithography comprises: determining multiple instances of the training mask pattern, where a dimension of the first part increases sequentially by a first step size among the multiple instances of the training mask pattern; and converting each of the multiple instances into a mask matrix.

In an embodiment, obtaining the training image pattern of the plasma lithography through the computation based on the model comprises: obtaining training image patterns corresponding to the multiple instances, respectively, of the training mask pattern through the computation based on the model; and converting the training image patterns into light-intensity matrices, respectively.

In an embodiment, converting each of the multiple instances into the mask matrix comprises: converting the first part into one or more elements of a first value in the mask matrix, and converting the second part into one or more elements of a second value of the mask matrix.

In an embodiment, obtaining the training image patterns corresponding to the multiple instances, respectively, of the training mask pattern through the computation based on the model comprises: acquiring light intensity at multiple positions within a single period of each of the training image patterns through the computation based on the model. Converting the training image patterns into light-intensity matrices, respectively, comprises: converting the light intensity at the multiple positions into the respective light-intensity matrix.

In an embodiment, determining the structure for the training on the imaging of the plasma lithography comprises: determining multiple instances of the training mask pattern, where a periodical dimension of the training mask pattern increases sequentially by a second step size among the multiple instances of the training mask pattern.

In an embodiment, training the fast imaging model through the training mask pattern and the training image pattern to obtain a trained imaging model for the training mask pattern comprises: converting the mask matrices, among which the dimension of training mask pattern is identical while the dimension of the first part is different, into first column vectors, respectively, of a target quantity, where the target quantity is equal to a quantity of the training mask patterns among which the dimension of training mask pattern is identical; converting light-intensity matrices corresponding to the mask matrices, among which the dimension of training mask pattern is identical while the dimension of the first part is different, into second column vectors, respectively, of the target quantity; combining the first column vectors into an input matrix; combining the second column vectors into an output matrix; and training the fast imaging model based on the input matrix and the output matrix.

In an embodiment, the first part is square.

In an embodiment, the method further comprises: determining a target structure for the imaging of the plasma lithography, where a target mask pattern in the target imaging structure is repeated periodically along the two directions in the target structure, and a shape of the target mask pattern is identical to a shape of the training mask pattern; and inputting the target mask pattern into the trained imaging model to obtain a target image pattern corresponding to the target mask pattern in the plasma lithography.

An apparatus for training on imaging of plasma lithography is provided according to an embodiment of the present disclosure. The apparatus comprises: a determining unit, configured to determine a structure for training on imaging of plasma lithography, where a training mask pattern repeats periodically along two directions in the structure; a simulating unit, configured to construct a model simulating the structure, and obtain a training image pattern of the plasma lithography through computation based on the model, where the training image pattern corresponds to the training mask pattern; and a training unit, configured to train a fast imaging model through the training mask pattern and the training image pattern to obtain a trained imaging model for the training mask pattern.

The method for training on the imaging of the plasma lithography is provided according to embodiments of the present disclosure. The method comprises following steps. The structure for training on the imaging of the plasma lithography is determined, where the training mask pattern repeats periodically along the two directions in the structure. The model simulating the structure is constructed, and the training image pattern of the plasma lithography is obtained through computation based on the model, where the training image pattern corresponds to the training mask pattern. That is, the model is constructed based on the structure and is utilized to simulate the training mask pattern repeating periodically along the two directions, and thereby the training image pattern corresponding to each instance of the training mask pattern can be computed. Afterwards, the fast imaging model is trained through the training mask pattern and the training image pattern to obtain the trained imaging model for the training mask pattern. That is, the fast imaging model for the training mask pattern repeating periodically along the two directions is first constructed, such that the training image pattern corresponding to each instance of the training mask pattern can be directly obtained for the plasma lithography. The trained imaging model can be utilized for fast imaging simulation, which meets a requirement of the plasma lithography in research.

### BRIEF DESCRIPTION OF THE DRAWINGS

Hereinafter drawings to be applied in embodiments of the present disclosure or in conventional technology are briefly described, in order to clarify illustration of technical solutions according to embodiments of the present disclosure or in conventional technology. Apparently, the drawings in the following descriptions are only some embodiments of the present disclosure, and other drawings may be obtained by those skilled in the art based on the provided drawings without exerting creative efforts

FIG. 1 shows a schematic structural diagram of a structure for training on imaging in plasma lithography.

FIG. 2 shows a schematic flow chart of a method for training on imaging of plasma lithography according to an embodiment of the present disclosure.

FIG. 3 shows a schematic top view of a structure for training on imaging according to an embodiment of the present disclosure.

FIG. 4 shows a schematic diagram of a simulated part of a structure for training on imaging of plasma lithography according to an embodiment of the present disclosure.

FIG. 5 shows a schematic diagram of a simulation result on an observation plane of imaging in plasma lithography according to an embodiment of the present disclosure.

FIG. 6 shows a schematic diagram of a mask matrix according to an embodiment of the present disclosure.

FIG. 7 shows a schematic diagram of a light-intensity matrix according to an embodiment of the present disclosure.

FIG. 8 shows a schematic diagram of processing on a mask matrix and a light-intensity matrix according to an embodiment of the present disclosure.

FIG. 9 shows a schematic diagram of a matrix multiplication according to an embodiment of the present disclosure.

FIG. 10 shows a schematic structural diagram of an apparatus for training on imaging of plasma lithography according to an embodiment of the present disclosure.

### DETAILED DESCRIPTION OF EMBODIMENTS

Hereinafter specific implementations of the present disclosure are described in detail in conjunction with the drawings to clarify and elucidate objectives, features, and advantages of the present disclosure.

Various details are set forth in following description for full understanding of the present disclosure. The present disclosure may be implemented in an embodiment different from those described herein. Those skilled in the art may make deduction without violating a concept of the present disclosure, and hence the present disclosure is not limited to embodiments disclosed as follows.

The present disclosure is described in detail in conjunction with schematic diagrams. In order to facilitate illustrating embodiments, a cross-sectional diagram of a device structure may not be enlarged to scale in all parts, and the schematic diagrams are only exemplary and shall not be construed as limitations on a protection scope of the present disclosure. In practice, a structure shall be manufactured with three spatial dimensions such as a length, a width, and a depth.

Photolithography is an important technique for manufacturing semiconductor devices, and develops rapidly along with the semiconductor technology. As a complement for mainstream photolithography means, plasma lithography is quite different from traditional lithography such as deep-ultraviolet lithography (DUVL) and extreme-ultraviolet lithography (EUVL).

Plasmon lithography is also known as surface plasmon lithography. In such technique, surface plasmon polaritons (SPPs) or localized surface plasmons are excited on an interface between metal and dielectric, and evanescent waves are amplified through resonance at an object (or a mask). The evanescent waves participate in an imaging process in which a photoresist is exposed, and thereby a pattern is transferred onto the photoresist.

The plasma lithography utilizes evanescent waves containing high-frequency information to implement near-field imaging, and thus can break through diffraction limits in the traditional photolithography means. Experiments have revealed that optical resolution under single exposure with a light wavelength of 365 nm can reach 20 nm, i.e., about 1/17 of the light wavelength, and may be even lower. The plasma lithography does not introduce additional optical lenses and short-wavelength light sources, which are complex and expensive. Moreover, the plasma lithography is compatible with materials and processing used in traditional photolithography. Hence, such technique has gradually developed into a new means for nano-level optical processing having high resolution and low costs.

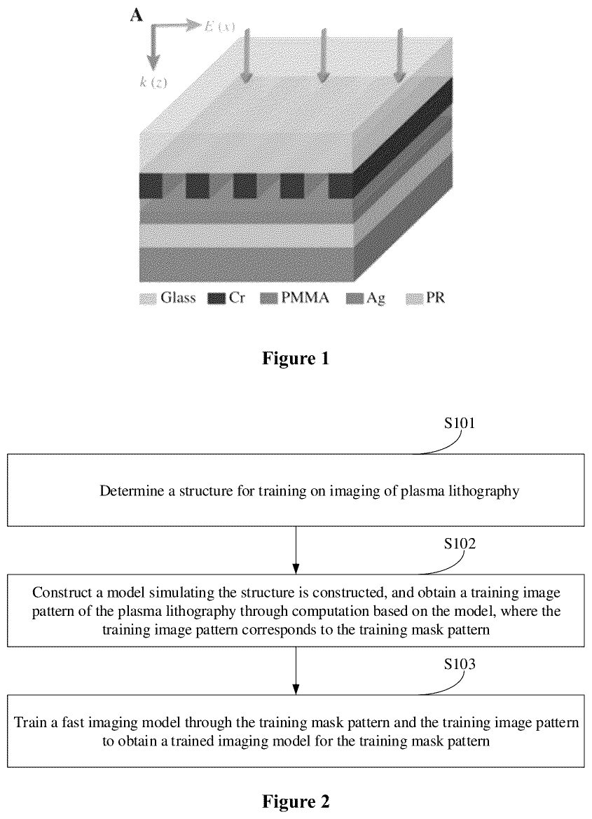

Generally, the plasma lithography is categorized into imaging lithography, interference lithography, and direct-writing lithography. The direct-writing lithography usually has no imaging structure, while the imaging lithography and the interference lithography have an imaging structure which includes a mask pattern. Reference is made to FIG. 1. As shown in FIG. 1, the imaging structure is a single-layer-metallic-film superlens structure, and comprises a quartz substrate (Glass), a mask pattern, an organic glass (Polymethyl methacrylate, PMMA), a metallic film, a photoresist (PR), and a reflective layer, which are stacked in the above-listed sequence. As examples, the mask pattern may be a chromium (Cr) mask, the metallic film may be silver (Ag), and the reflective layer may be silver.

An imaging process of plasma lithography using the imaging structure may be described roughly as follows. Light incident onto the mask pattern diffracts and thereby produces various diffraction orders comprising low-frequency transmission waves and high-frequency evanescent waves. The diffraction light passes the mask pattern, transmits through the single-layer metallic film, and then reaches photoresist layer. Thereby, information concerning the mask pattern can be transferred onto the photoresist. During the transferring, the SPPs may be excited at an interface between metal and dielectric in a case that a wave vector of a diffraction order of the high-frequency evanescent waves is consistent with that of the SPPs at such interface. In such case, the high-frequency evanescent waves are amplified through resonance and can thereby reach the photoresist layer, which increases imaging resolution of the photolithography. Moreover, the reflective layer is usually disposed behind the photoresist layer, such that an imaging effect on the photoresist layer is further improved through reflection resonance.

A basis for comprehensive study of plasma lithography is evaluating imaging of on the photoresist layer accurately and quantitatively under different conditions such as different mask patterns, different imaging structures, and different materials. Such basis facilitates better understanding and better explanation on experimental phenomena, and may further guide optimization of processing parameters and improvement on imaging performances (such as optical resolution, depth of focus, imaging contrast, or the like). Specifically, an imaging model for plasma lithography may be established and studied through numerical means or analytical means. The numerical means may utilize finite difference time domain (FDTD), finite element method (FEM), or the like. The analytical means may utilize optical transfer function (OTF). The numerical means is more accurate, but its calculation consumes a lot of time and hence has low efficiency, especially when expanding a range of simulation range or solving a three-dimensional model (which corresponds to a two-dimensional mask pattern). The analytical means is fast in calculation, but has decreased accuracy in imaging results due to its approximation on the mask. Currently, the analytical means is only applicable to two-dimensional models corresponding to one-dimensional periodic patterns, and scarce research has been conducted on three-dimensional models corresponding to two-dimensional patterns.

Therefore, fast imaging for two-dimensional patterns in plasma lithography has become a hot topic in current research.

A method for training on imaging of plasma lithography is provided according to

embodiments of the present disclosure. The method comprises following steps. A structure for training on an imaging of the plasma lithography is determined, where a training mask pattern repeats periodically along two directions in the structure. A model simulating the structure is constructed, and a training image pattern of the plasma lithography is obtained through computation based on the model, where the training image pattern corresponds to the training mask pattern. That is, the model is constructed based on the structure and is utilized to simulate the training mask pattern repeating periodically along the two directions, and thereby the training image pattern corresponding to each instance of the training mask pattern can be computed. Afterwards, a fast imaging model is trained through the training mask pattern and the training image pattern to obtain a trained imaging model for the training mask pattern. That is, the fast imaging model for the training mask pattern repeating periodically along the two directions is first constructed, such that the training image pattern corresponding to each instance of the training mask pattern can be directly obtained for the plasma lithography. The trained imaging model can be utilized for fast imaging simulation, which meets a requirement of the plasma lithography in research.

Hereinafter specific embodiments are described in detail in conjunction with the drawings to facilitate understanding technical solutions and technical effects of the present disclosure.

Reference is made to FIG. 2, which a flowchart of a method for training on imaging of plasma lithography according to an embodiment of the present disclosure. The method comprises following steps S101 to S103.

In step S101, a structure for training on imaging of plasma lithography is determined.

In an embodiment, there may be various types of structures for imaging of the plasma lithography. The structure for training on imaging of plasma lithography may be first acquired, and a training mask pattern repeats periodically along two directions in the structure.

In an embodiment, the structure may comprise metallic film(s) and dielectric film(s) that are alternately arranged, and may comprise a reflective layer disposed behind the photoresist. Reference is made to FIG. 1. The structure may comprises a quartz substrate, a mask, the metallic film(s) and the dielectric film(s) that are alternately arranged, a spacer layer, a photoresist, and the reflective layer, which are arranged in the above-listed sequence along an incident direction of light. Parameters of the structure may be as follows. The mask is a Cr mask with a thickness of 40 nm, and transparent TiO₂ layer is disposed between adjacent Cr elements. The metallic film(s) and the dielectric film(s) that are alternately arranged may be TiO₂/Ag films. A thickness of the spacer layer may be 20 nm. A thickness of the photoresist may be 20 nm. The reflective layer may be made of Ag. A dielectric constant of the quartz substrate may be 2.25, a dielectric constant of the Cr mask may be −8.55+8.96 i, a dielectric constant of the TiO₂ film(s) and Ag film(s) may be 7.8375+0.2800 i and −2.3879+0.1573 i, respectively, a dielectric constant of the spacer layer may be 1, a dielectric constant of the photoresist may be 2.59, and a dielectric constant of the reflective layer may be −2.4+0.45 i. Illumination for imaging of the plasma lithography may utilize a normally incident plane waves, e.g., linearly polarized light, having a wavelength of 365 nm.

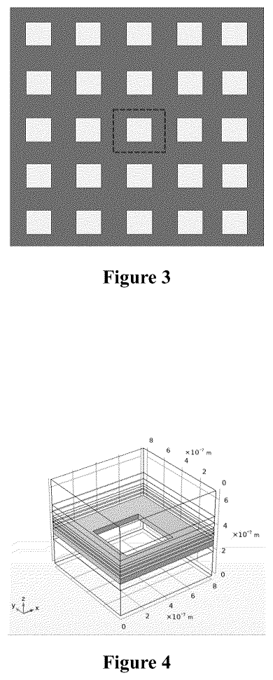

Reference is made to FIG. 3, which is a schematic top view of a structure for training on imaging. In an embodiment, the structure may have a mask layer with through-holes. Training mask pattern that repeat periodically along the two directions in the structure may comprise a through hole and a region surrounding such through hole. That is, the training mask patterns may comprise a first part configured to be transparent and a second part configured to be opaque, and the second part surrounds the first part. The first part corresponds to the through hole, and a material of the first part may be transparent TiO₂. The second part corresponds to the region surrounding the through hole, and the material of the second part may be opaque Cr. A shape of the through hole may be determined according to an actual situation. In an embodiment, square through holes are utilized, that is, that is, the first part is square.

As an example, the training mask pattern is a part enclosed by a dotted box as shown in FIG. 3, and a square in the box represents the first part.

In an embodiment, under the same type of the structure, the training mask pattern may be configured with different periodical dimensions, and may be configured with the first parts of different dimensions. That is, the same structure may correspond to different training mask patterns. Hereinafter a process of acquiring the different training mask patterns is illustrated in detail.

In a first means, multiple training mask patterns among which the periodical dimensions increase sequentially by a second step size are acquired. That is, the training mask patterns varying gradually in periodical dimension are acquired to serve as a training input of a fast imaging model.

As an example, the second step size is 5 nm, and the periodical dimension of the training mask pattern may be gradually increased from 170 nm to 300 nm by an increment of 5 nm. That is, twenty-seven training mask patterns can be obtained.

In a second means, multiple training mask patterns among which the dimensions of the first parts increase sequentially by a first step size are acquired. That is, the training mask patterns varying gradually in dimension of the first part are acquired to serve as a training input of a fast imaging model.

As an example, the first part is square, the first step size is 10 nm, and the dimension of the first part may be gradually increased from 10 nm to 140 nm by an increment of 10 nm. That is, eleven training mask patterns can be obtained.

In practice, both the periodical dimension and the dimension of the first part of the training mask pattern may vary. That is, the dimension of the first part corresponding to the same periodical dimension may also vary. Accordingly, training mask patterns having different dimensions of the first parts may be further obtained under the different periodical dimensions.

As an example, the periodical dimension is adjusted as above to obtain the twenty-seven training mask patterns, and the dimension of the first part is adjusted as above to obtain the eleven training mask patterns. Thus, 27×11=294 training mask patterns can be obtained in total.

In step S102, a model simulating the structure is constructed, and a training image pattern of the plasma lithography is obtained through computation based on the model, where the training image pattern corresponds to the training mask pattern.

In an embodiment, simulation software may be utilized to perform three-dimensional modeling on the structure according to parameters of the structure, so as to obtain the model simulating the structure. Give periodicity in the structure, only a part of the structure corresponding to one period is required to be modelled, as shown in FIG. 4. The simulation of the part as shown in FIG. 4 corresponds to the training mask pattern enclosed by the dotted box as shown in FIG. 3. The square hole in FIG. 4 is the first part of the training mask pattern.

After the model is constructed, the imaging of plasma lithography may be simulated on a basis of the model to obtain the training image pattern corresponding to the training mask patterns.

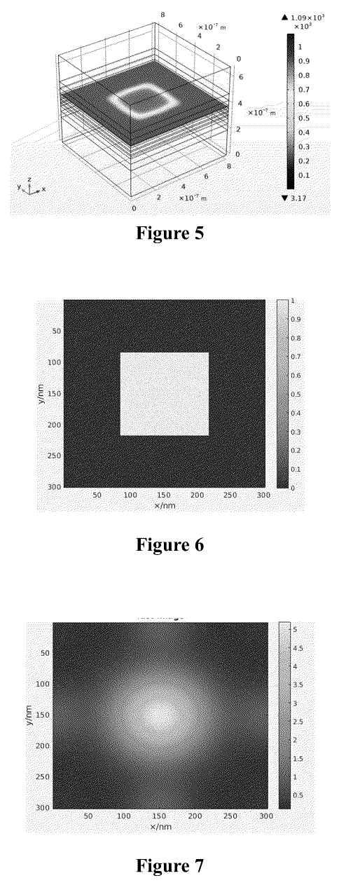

After constructing the model simulating the structure for training on imaging, the simulation software may further compute distribution of light intensity corresponding to the structure on a basis of the model. The distribution of light intensity represents the training image pattern of plasma lithography. The distribution of light intensity refers to that on an observation plane of the photoresist, and the observation plane may be a central plane within the photoresist layer. Reference is made to FIG. 5. The distribution of light intensity in the training image pattern corresponding to the single training mask pattern may be obtained through computation based on the model.

In an embodiment, the same structure may correspond to the different training mask patterns. Hence, the training image pattern corresponding to each training mask patter may be obtained through computation based on the model, such that the different training mask patterns and their corresponding training image patterns can be utilized for training the fast imaging model in subsequent steps.

In step S103, a fast imaging model is trained through the training mask pattern and the training image pattern to obtain a trained imaging model for the training mask pattern.

Herein after the training mask pattern is obtained and the training image pattern is computed, they may be utilized to train the fast imaging model, so as to obtain the trained imaging model for training mask patterns that repeat periodically along the two dimensions.

In an embodiment, the training mask pattern may be converted into a mask matrix, and the training image pattern may be converted into a light-intensity matrix. The mask matrix and the light-intensity matrix are utilized to train the fast imaging model.

When converting the training mask pattern into the mask matrix, the first part of the training mask pattern may be converted into element(s) having a first value in the mask matrix, and the second part may be converted into element(s) having a second value in the mask matrix, so as to distinguish the first part from the second part in the mask matrix. For example, the first value and the second value are 1 and 0, respectively. The mask matrix may be as shown in FIG. 6.

The distribution of light intensity at the observation plane of the photoresist is actually obtained when the simulation software computes the training image pattern. That is, light intensity at multiple positions within a single period of the training image pattern is computed through the simulation software, and the training image pattern may be represented by the values of the light intensity at such positions. Hence, when converting the training image pattern into the light-intensity matrix, the light intensity at the multiple positions in the single period of the training image pattern may be converted into the light-intensity matrix, as shown in FIG. 7. In an embodiment, the distribution of light intensity is sampled with a step size of 1 nm×1 nm during the conversion.

In an embodiment, after the mask matrix is obtained from the training mask pattern and the light-intensity matrix is obtained from the training image pattern, the mask matrices of the training mask patterns, which are different in the dimension of the first part while identical in the periodical dimension, and their corresponding light-intensity matrices are processed to generate an input matrix and an output matrix, respectively, for training the fast imaging model.

The mask matrices corresponding to the different dimensions of the first parts under the same periodical dimension may be converted into first column vectors, respectively, of a target quantity. Their light-intensity matrices may be converted into second column vectors, respectively, of the target quantity. The target quantity is equal to a quantity of the training mask patterns having such periodical dimension. The first column vectors of the target quantity are combined into the input matrix, and the second column vectors of the target quantity are combined into the output matrix.

That is, the periodical dimension serves as a basis, and the mask matrices corresponding to the different dimensions of the first parts under the same periodical dimension and their corresponding light-intensity matrices are vectorized. The resultant column vectors are then combined to obtain the input matrix and the output matrix.

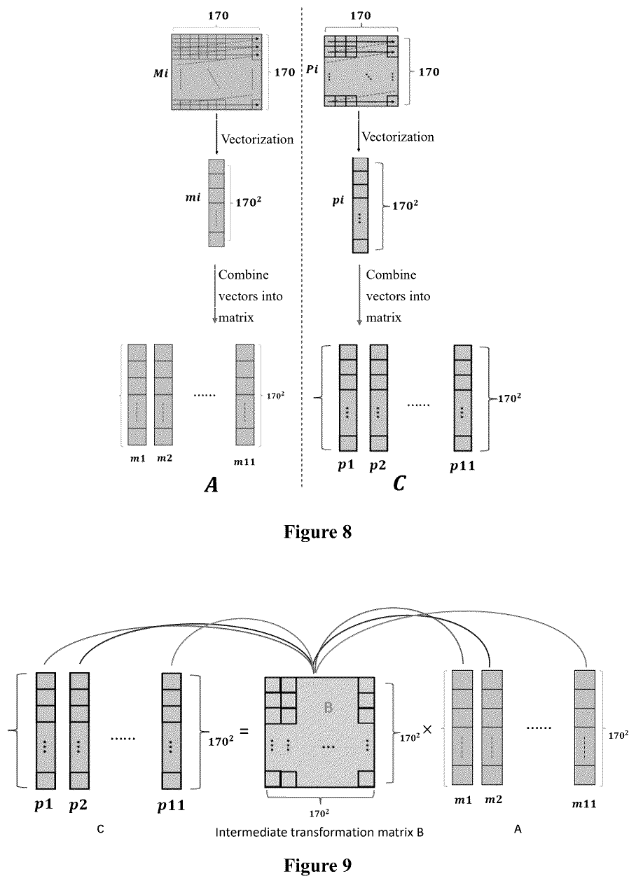

Reference is made to FIG. 8. Eleven training mask patterns having different dimensions of the first part under the periodical dimension of 170 nm are vectorized, that is, eleven mask matrices Mi having a size of 170×170 are vectorized into eleven first column vectors mi having a length of 170², where i represents a sequential number of each mask pattern and i ranges from 1 to 11. The first column vectors mi are sequentially arranged to form an input matrix A₁₇₀_{²}_{×11} having a size of 170²×11. The same processing is applied on the light-intensity matrices Pi. That is, the eleven light-intensity matrices Pi having a size of 170×170 is vectorized into eleven second column vectors pi having a length of 170², and the second column vectors pi are sequentially arranged to form an output matrix C₁₇₀_{²}_{×11} having a size of 170²×11.

In an embodiment, an intermediate transformation matrix from the input matrix to the output matrix is fitted based on the input matrix and the output matrix through a least square method.

As an example, the input matrix of the fast imaging model may be denoted by A, the output matrix of the fast imaging model may be denoted by C, and the intermediate transformation matrix B from A to C may be fitted based on the input matrix A and the output matrix C through the least square method. Approximately, the matrices A, B and C satisfy a relationship C=B·A, where the symbol “·” represents matrix multiplication, as shown in FIG. 9.

Thereby, the mask matrix and the light-intensity matrix are vectorized, and then the column vectors are arranged to from the input matrix A and the output matrix C. The above matrix multiplication reflects that the light intensity of each element in the output matrix C is a weighted sum of elements in the mask matrix having the same periodical dimension. In addition, the vectorization and the combination can meet a requirement of linear fitting in the least square method and a requirement of the matrix multiplication on matrix dimensions. Accordingly, such training process is capable to compute the respective intermediate transformation matrix under each periodical dimension, and the fast imaging model can thereby be trained for the different periodical dimensions.

In an embodiment, the periodical dimension of the training mask pattern is adjusted to obtain the twenty-seven training mask patterns, and the intermediate transformation matrix Bⱼ under each periodical dimension is obtained, where j is an integer ranging from 1 to 27.

The trained imaging model is obtained after the training process. In an embodiment, the intermediate transformation matrix B from input A to output C is fitted through the least square method, and then the trained imaging model may be tested. That is, the intermediate transformation matrix B is tested to determine an effect, on the imaging process, of the trained imaging model based on test results. The trained imaging model may be further optimized based on the test results.

In an embodiment, multiple test mask patterns may be obtained, and the dimension of first part increases sequentially by a third step size among the test mask patterns, where the third step size is smaller than the first step size. That is, the trained imaging model may be tested by utilizing the third step size, which is smaller than the first step size utilized when training the fast imaging model. Thereby, the trained imaging model can be tested to the most extent. The multiple test mask patterns under the same periodical dimension are converted into an input matrix. The respective test image patterns corresponding to the test mask patterns are obtained, and the test image patterns corresponding to the same periodical dimension are converted into an output matrix. The trained imaging model is tested based on the input matrix and output matrix.

In practice, when testing the trained imaging model by utilizing the multiple test mask patterns having the third step size, a process of the testing may refer to the description concerning the training mask patterns, and is not illustrated in detail herein.

In an embodiment, the dimensions of the first part increases sequentially from 40 nm to 140 nm by the third step size smaller than 10 nm, e.g., 5 nm, among the multiple test mask patterns.

In an embodiment, after acquiring the test results, a calculation results may be obtained through a strict simulation means, and a deviation between the test results and the calculation result may be calculated to reflect the effect of the trained imaging model on the imaging process.

Herein the fast imaging model computed based on the least square fitting is provided, and the model can directly obtain a spatial image on the photoresist from the mask pattern. Compared with the strict simulation calculation means, the method provided herein has much greater running speed while loss little accuracy. In practice, the running speed and calculation accuracy of strict simulation software is related to fineness of a grid. Herein the calculation accuracy of trained imaging model is related to precision of training data and a quantity of samples, and the running speed is related to the quantity of samples. When conditions are substantially the same, the trained imaging model is capable to implement a fast imaging process. The method provided herein can address issues in simulating the imaging process of imaging structures having a two-dimensional periodical mask pattern.

Herein after training the fast imaging model, the trained imaging model may be configured to generate a target image pattern corresponding to a target mask pattern in a target imaging structure. In an embodiment, the target imaging structure for imaging of plasma lithography may be obtained, the target mask pattern repeat periodically along the two dimensions in the target imaging structure, and the target mask pattern and the training mask pattern are identical in shape. The target mask pattern is inputted into the trained imaging model to obtain the target image patter corresponding to the target mask pattern.

The method for training on the imaging of the plasma lithography is provided according to embodiments of the present disclosure. The method comprises following steps. The structure for training on the imaging of the plasma lithography is determined, where the training mask pattern repeats periodically along the two directions in the structure. The model simulating the structure is constructed, and the training image pattern of the plasma lithography is obtained through computation based on the model, where the training image pattern corresponds to the training mask pattern. That is, the model is constructed based on the structure and is utilized to simulate the training mask pattern repeating periodically along the two directions, and thereby the training image pattern corresponding to each instance of the training mask pattern can be computed. Afterwards, the fast imaging model is trained through the training mask pattern and the training image pattern to obtain the trained imaging model for the training mask pattern. That is, the fast imaging model for the training mask pattern repeating periodically along the two directions is first constructed, such that the training image pattern corresponding to each instance of the training mask pattern can be directly obtained for the plasma lithography. The trained imaging model can be utilized for fast imaging simulation, which meets a requirement of the plasma lithography in research.

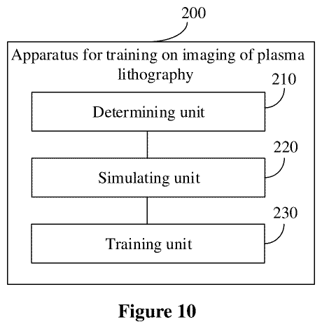

On a basis of the foregoing method, an apparatus for training on imaging of plasma lithography is provided according to an embodiment of the present disclosure. Reference is made to FIG. 10, which is a structural diagram of the apparatus for training on imaging of plasma lithography according to an embodiment of the present disclosure. The apparatus 200 for training on imaging of plasma lithography according to an embodiment of the present disclosure comprises a determining unit 210, a simulating unit 220, and a training unit 230.

The determining unit 210 is configured to determine a structure for training on imaging of plasma lithography, where a training mask pattern repeats periodically along two directions in the structure.

The simulating unit 220 is configured to construct a model simulating the structure, and obtain a training image pattern of the plasma lithography through computation based on the model, where the training image pattern corresponds to the training mask pattern.

The training unit 230 is configured to train a fast imaging model through the training mask pattern and the training image pattern to obtain a trained imaging model for the training mask pattern.

In an embodiment, the training mask pattern comprises a first part configured to be transparent and a second part configured to be opaque, where the second part surrounds the first part. The determining unit 210 is configured to: determine multiple instances of the training mask pattern, where a dimension of the first part increases sequentially by a first step size among the multiple instances of the training mask pattern; and convert each of the multiple instances into a mask matrix.

In an embodiment, the simulating unit 220 is configured to: obtain training image patterns corresponding to the multiple instances, respectively, of the training mask pattern through the computation based on the model; and convert the training image patterns into light-intensity matrices, respectively.

In an embodiment, the simulating unit 220 is configured to: convert the first part into one or more elements of a first value in the mask matrix, and convert the second part into one or more elements of a second value of the mask matrix.

In an embodiment, the simulating unit 220 is configured to: acquire light intensity at multiple positions within a single period of each of the training image patterns through the computation based on the model; and convert the light intensity at the multiple positions into the respective light-intensity matrix.

In an embodiment, the determining unit 210 is configured to: determine multiple instances of the training mask pattern, where a periodical dimension of the training mask pattern increases sequentially by a second step size among the multiple instances of the training mask pattern.

In an embodiment, the training unit 230 is configured to: convert the mask matrices, among which the dimension of training mask pattern is identical while the dimension of the first part is different, into first column vectors, respectively, of a target quantity, where the target quantity is equal to a quantity of the training mask patterns among which the dimension of training mask pattern is identical; convert light-intensity matrices corresponding to the mask matrices, among which the dimension of training mask pattern is identical while the dimension of the first part is different, into second column vectors, respectively, of the target quantity; combine the first column vectors into an input matrix; combine the second column vectors into an output matrix; and train the fast imaging model based on the input matrix and the output matrix.

In an embodiment, the first part is square.

In an embodiment, the apparatus further comprises an applying unit, configured to: determine a target structure for the imaging of the plasma lithography, where a target mask pattern in the target imaging structure is repeated periodically along the two directions in the target structure, and a shape of the target mask pattern is identical to a shape of the training mask pattern; and input the target mask pattern into the trained imaging model to obtain a target image pattern corresponding to the target mask pattern in the plasma lithography.

The embodiments of the present disclosure are described in a progressive manner, and each embodiment places emphasis on the difference from other embodiments. Therefore, one embodiment can refer to other embodiments for the same or similar parts. Since the apparatuses disclosed in the embodiments correspond to the methods disclosed in the embodiments, the description of the apparatuses is simple, and reference may be made to the relevant part of the methods.

The foregoing embodiments are only preferred embodiments of the present disclosure, and do not limit the present disclosure in any form. The preferred embodiments according to the disclosure are disclosed above, and are not intended to limit the present disclosure. With the method and technical content disclosed above, those skilled in the art can make some variations and improvements to the technical solutions of the present disclosure, or make some equivalent variations on the embodiments without departing from the scope of technical solutions of the present disclosure. All simple modifications, equivalent variations and improvements made based on the technical essence of the present disclosure without departing the content of the technical solutions of the present disclosure fall within the protection scope of the technical solutions of the present disclosure.

1. A method for training on imaging of plasma lithography, comprising:
determining a structure for training on imaging of plasma lithography, wherein a training mask pattern repeats periodically along two directions in the structure;
constructing a model simulating the structure;
obtaining a training image pattern of the plasma lithography through computation based on the model, wherein the training image pattern corresponds to the training mask pattern; and
training a fast imaging model through the training mask pattern and the training image pattern to obtain a trained imaging model for the training mask pattern.

2. The method according to claim 1, wherein:
the training mask pattern comprises a first part configured to be transparent and a second part configured to be opaque, wherein the second part surrounds the first part; and
determining the structure for the training on the imaging of the plasma lithography comprises:
determining a plurality of instances of the training mask pattern, wherein a dimension of the first part increases sequentially by a first step size among the plurality of instances; and
converting each instance in the plurality of instances into a mask matrix.

3. The method according to claim 2, wherein obtaining the training image pattern of the plasma lithography through the computation based on the model comprises:
obtaining training image patterns, each of which corresponds to a respective instance of the plurality of instances, through the computation based on the model; and
converting the training image patterns into light-intensity matrices, respectively.

4. The method according to claim 2, wherein converting each instance in the plurality of instances into the mask matrix comprises:
converting the first part into one or more elements of a first value in the mask matrix, and
converting the second part into one or more elements of a second value of the mask matrix.

5. The method according to claim 3-claim 2, wherein:
obtaining training image patterns, each of which corresponds to a respective instance of the plurality of instances, through the computation based on the model comprises:
acquiring light intensity at a plurality of positions within a single period of each of the training image patterns through the computation based on the model; and
converting the training image patterns into the light-intensity matrices, respectively, comprises:
converting the light intensity at the plurality of positions into a respective one of the light-intensity matrices.

6. The method according to claim 1, wherein determining the structure for the training on the imaging of the plasma lithography comprises:
determining a plurality of instances of the training mask pattern, wherein a periodical dimension of the training mask pattern increases sequentially by a second step size among the plurality of instances.

7. The method according to claim 3, wherein training the fast imaging model through the training mask pattern and the training image pattern to obtain a trained imaging model for the training mask pattern comprises:
converting the mask matrices of first instances among the plurality of instances into first column vectors, respectively, wherein the first instances are identical in a periodical dimension of the training mask pattern and different in the dimension of the first part;
converting the light-intensity matrices corresponding to the mask matrices of the first instances, into second column vectors, respectively;
combining the first column vectors into an input matrix;
combining the second column vectors into an output matrix; and
training the fast imaging model based on the input matrix and the output matrix.

8. The method according to claim 2, wherein the first part is square.

9. The method according to claim 1, further comprising:
determining a target structure for the imaging of the plasma lithography, wherein a target mask pattern in the target imaging structure is repeated periodically along the two directions in the target structure, and a shape of the target mask pattern is identical to a shape of the training mask pattern; and
inputting the target mask pattern into the trained imaging model to obtain a target image pattern corresponding to the target mask pattern in the plasma lithography.

10. (canceled)

11. The method according to claim 9, further comprising:
optimizing parameters of the imaging of the plasma lithography based on the target image pattern; and
performing the plasma lithography using the target structure and the optimized parameter of the imaging.

12. An apparatus for training on imaging of plasma lithography, comprising:
a memory storing computer-readable instructions; and
a processor, wherein the computer-readable instructions when executed by the processor configure the apparatus to:
determine a structure for training on imaging of plasma lithography, wherein a training mask pattern repeats periodically along two directions in the structure;
construct a model simulating the structure;
obtain a training image pattern of the plasma lithography through computation based on the model, wherein the training image pattern corresponds to the training mask pattern; and
train fast imaging model through the training mask pattern and the training image pattern to obtain a trained imaging model for the training mask pattern.

13. A non-transitory computer-readable medium, storing computer-readable instructions, wherein the computer-readable instructions when executed by a processor implement:
determining a structure for training on imaging of plasma lithography, wherein a training mask pattern repeats periodically along two directions in the structure;
constructing a model simulating the structure;
obtaining a training image pattern of the plasma lithography through computation based on the model, wherein the training image pattern corresponds to the training mask pattern; and
training fast imaging model through the training mask pattern and the training image pattern to obtain a trained imaging model for the training mask pattern.
